(19) United States
(12) Patent Application Publication
(10) Pub. No.: US 2011/0113252 A1
(43) Pub. Date: May 12, 2011

(54) CONCIERGE REGISTRY AUTHENTICATION SERVICE

(76) Inventors: Mark Krischer, Pymble (AU); James Edward Burns, Stratham, NH (US); Nancy Cam-Winget, Mountain View, CA (US); Esteban Raul Torres, San Francisco, CA (US)

(21) Appl. No.: 12/613,784

(22) Filed: Nov. 6, 2009

(51) Int. Cl. H04L 9/32

(52) U.S. Cl. 713/175; 713/176

(57) ABSTRACT

In an example embodiment described herein is an apparatus comprising a transceiver configured to send and receive data, and logic coupled to the transceiver. The logic is configured to determine from a beacon received by the wireless transceiver whether an associated wireless device sending the beacon supports a protocol for advertising available services from the associated wireless device. The logic is configured to send a request for available services from the associated wireless device via the wireless transceiver responsive to determining the associated wireless device supports the protocol. The logic is configured to receive a response to the request via the wireless transceiver, the response comprising a signature. The logic is configured to validate the response by confirming the signature comprises network data cryptographically bound with service data.

### TECHNICAL FIELD

The present disclosure relates generally to authentication of services advertised by a network.

### BACKGROUND

A Mobile Service Advertisement Protocol, such as a Concierge Service, creates some very interesting opportunities, allowing the next generation of devices, such as smart phones, to automatically present services provided by a Wireless Local Area Network (WLAN) without the need for a user to perform complex configuration of the device. For example, a WLAN employing a mobile Concierge Service can advertise network services along with a provider of the services. A mobile device receiving an advertisement may output (for example display and/or provide an audiovisual signal, etc.) the advertised service on the mobile device allowing a user associated with the mobile device to access the advertised service. It also creates, however, a potential for abuse, for example spoofed applications may be masquerading as legitimate applications, spoofed applications may be employed for luring potential victims and/or a potential vulnerability to spam attacks.

### BRIEF DESCRIPTION OF THE DRAWINGS

The accompanying drawings incorporated herein and forming a part of the specification illustrate the examples embodiments.

FIG. 1 illustrates an example of a wireless local area network configured in accordance with an example embodiment.

FIG. 2 illustrates an example of a wireless local area network with a service provider configured in accordance with an example embodiment.

FIG. 3 illustrates an example signal diagram for a wireless mobile unit to receive advertising services from a wireless local area network.

FIG. 4 is illustrates an example signal diagram for a wireless mobile unit to receive advertising services from a wireless local area network that includes a service provider.

FIG. 5 is a block diagram of a mobile device upon which an example embodiment may be implemented.

FIG. 6 is a block diagram of a server upon which an example embodiment may be implemented.

FIG. 7 illustrates an example of a computer system upon which an example embodiment may be implemented.

FIG. 8 illustrates an example of a methodology performed by a mobile device to obtain network advertising services.

FIG. 9 illustrates an example of a methodology performed by a server to provide advertising services.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein an apparatus comprising a transceiver configured to send and receive data, and logic coupled to the transceiver. The logic is configured to determine from a signal received by the transceiver whether an associated device sending the signal supports a protocol for advertising available services available from the associated device. The logic is configured to send a request for available services from the associated device via the transceiver responsive to determining the associated device supports the protocol. The logic is configured to receive a response to the request via the transceiver, the response comprising a signature. The logic is configured to validate the response by confirming the signature comprises network data cryptographically bound with service data.

In accordance with an example embodiment, there is disclosed herein an apparatus comprising an interface configured to send and receive data and logic coupled to the interface. The logic is configured to receive a get advertising services request from the interface. The logic is configured to generate a response to the get advertising request, the response comprising a signature that comprises network data cryptographically bound with service data. The logic is configured to send the response to the get advertising request via the interface.

In accordance with an example embodiment, there is disclosed herein a method comprising receiving a signal, such as a beacon or probe response, from an access network provider. The method further comprises determining from the signal whether the access network provider supports a protocol for advertising available services. A list of available services is requested from the access network provider. A response to the request is received, the response comprises a signature. The response is validated, wherein validating the response comprises confirming the signature comprises network data cryptographically bound with service data.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In an example embodiment, pre-association service advertisements are delivered to a non-access point (AP) wireless station (STA) when the wireless station is within range of an AP. Each service is described by a service descriptor that defines a type of service, a network entry point (for example a Service Set Identifier or “SSID”), a queue for the end user (for example an icon), a uniform resource locator (URL) for acquiring the service, etc. In an example embodiment, the layer 2 identifier (SSID) is bound to a layer 7 element (for example the URL) to authenticate the source of the advertisement. As used herein, a layer comports the Open Systems Interconnection (OSI) model. For example, layer 1 is the physical layer, layer 2 is the data link layer which manages the interaction of devices with a shared medium (the Media Access Control (MAC) layer is a sub-layer of layer 2), layer 3 is the network layer (the best known example of a layer 3 protocol is the Internet Protocol “IP”), and layer 7 is the application layer.

In particular embodiments, when a non-AP STA makes a request for a list of services, the STA includes a nonce to identify this particular request. A node in the infrastructure network creates a response comprising a list of services, includes the nonce from the non-AP STA (for replay protection) and signs the response with a private key.

Any suitable trusted signing entity may be used in the example embodiments described herein. For example the trusted signing entity may be rooted in a public certificate authority (CA) such as Verisign, Thawte, etc. As another example, the trusted signing entity may be rooted in a private certificate authority such as Cisco (the assignee of the present application), IBM, etc. As yet another example, the trusted signing entity may be the network access provider such as T-Mobile, AT&T, Boingo, etc. Still another example, the trusted signing entity may be the application service provider (for example Target, Westfield, Best Buy, Frys, etc.).

The validation of service descriptors allows STAs and APs to validate all broadcasted services and optionally report spoofed services prior to a STA joining a network. With a secure concierge capability in place, APs and STAs can report on spoofed services they detect in their environments. Icons (services) which cannot be validated are not presented to the end user and can optionally be silently flagged to the network.

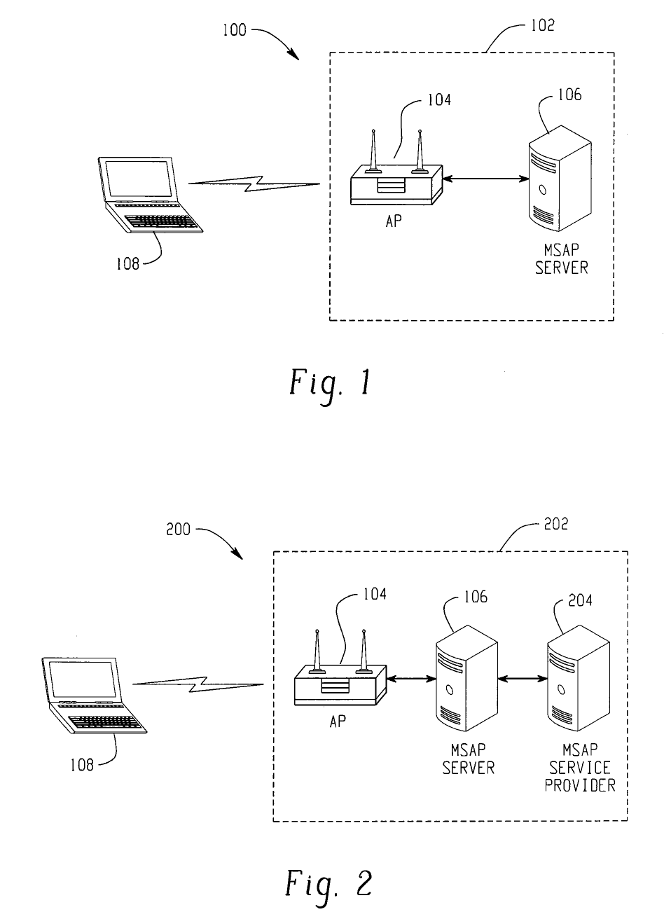

FIG. 1 illustrates an example of a wireless local area network 100 configured in accordance with an example embodiment. Network 100 comprises a service provider network 102 and a mobile device 108 in wireless communication with service provider network 102. Service provider network 102 comprises an access point (AP) 104 and a Mobile Service Advertisement Protocol (MSAP) compatible server 106 coupled to AP 104. As used herein, a MSAP is a protocol that manages services offered by the higher layers (in the OSI model) that are to be advertised by the network edge (in this example AP 104). The Institute of Electric and Electronics Engineers is currently promulgating a standard, IEEE 802.11u, which network 100 may employ in an example embodiment. Note that although the description herein describes mobile device 108 in wireless communication with access point 104, those skilled in the art should readily appreciate the communication link between mobile device 108 and access point 104 may be a wired link, or a combination of wireless and wired communication link.

In an example embodiment, AP 104 sends signals, such as beacons and responses to probes, advertising that it supports an advertisement (such as IEEE 802.11u Get Advertising Services “GAS”, MSAP or similar type of) protocol for advertising available services from network 102 accessible through AP 104. Mobile device 108 receives the beacons (or probe response) and can determine that AP 104 (also referred to herein as an Access Network Provider or “ANP”) supports an advertisement protocol. In response, mobile device 108 can send a request for services (for example a “GAS” request) to AP 104. AP 104 forwards the request to MSAP server 106.

MSAP server 106 generates a response to the request. The response includes network data and service data. MSAP server 106 also generates a signature that cryptographically binds the network data and service data, and the signature is included with the response. For example, MSAP may construct an authenticated response including a nonce, service data, network data and a Message Integrity Check (MIC) defined as RSA (MSAP-Server-private-key, SHA-256 (Nonce|Service Data|Network Data)), where RSA is Rivest, Shamir, & Adleman algorithm and SHA-256 is a Secure Hashing Algorithm, 256 bits. The response is sent to AP 104. The response is forwarded from AP 104 to mobile device 108.

Mobile device 108, upon receiving the response validates the response. In an example embodiment, mobile device 108 is configured to validate the response by confirming the signature comprises network data cryptographically bound with service data. In accordance with an aspect of an example embodiment, if the response is validated as authentic, then mobile device 108 will allow communications with AP 104. For example, in a MSAP application, if the response is valid, mobile device 108 will allow an advertisement sent by AP 104 to be processed. For example, an icon may be displayed on a user interface or an audio signal may be output.

In particular embodiments, mobile device 108 can decide whether to associate can choose a Service Set Identifier (SSID) on AP 104 (as there may be more than one service provided by the AP) that maps to the service the mobile device 108 is seeking. Validation of the signature (there may also a signature in the service-data included by the service provider that validates the service) helps provide further proof of the service validation and mitigation of phishing attack. The combination of both signatures can provide “full confirmation” against phishing attack. For example, the first signature provided by the service provider is the primary proof, and the second signature provided by the ANP (e.g. AP 104 in this example) serves to prove that the ANP is authorized to provide the service and has bound its response to the request by including the authenticated nonce provided by the requester.

If, however, the response sent by AP 104 is not valid, mobile device will discontinue communicating with AP 104. For example, mobile device 108 will suppress displaying an icon to the user interface. This protects against phishing attacks and against spam.

In an example embodiment, the request for available services sent by mobile node 108 to AP 104 comprises a nonce. MSAP server 108 is further configured to include the nonce in the signature. In validating the response, mobile node 108 verifies the signature includes the nonce.

In an example embodiment, the network data comprises a basic service set identifier (BSSID). In another example embodiment, the network data comprises a service set identifier (SSID) corresponding to an advertised service. In still another example embodiment, the network data comprises a plurality of service set identifiers (SSIDs) corresponding to a plurality of advertised services. In yet another example embodiment, the network data comprises a domain name. In still yet another example embodiment, the network data comprises a network access identifier (NAI). In yet still another example embodiment, the network data comprises a homogeneous extended service set identifier HESSID). In still yet another example embodiment the network data comprises 802.11 association capabilities such as Extensible Authentication Protocol (EAP) method and/or credential types. Other example embodiments include combinations of the aforementioned data.

In an example embodiment, the service data comprises an icon image and/or a reference for acquiring an icon image. In another example embodiment, the service data comprises a service provider identity. In still another example embodiment, the service data comprises a service Uniform Resource Locator (URL). In yet another example embodiment, the service data comprises a public key. In an example embodiment, the service data comprises a certificate signed by a certificate authority. In another example embodiment, the service data comprises a certificate signed by a registration authority. Other example embodiments include combinations of the aforementioned data.

In an example embodiment, where the service data comprises a certificate signed by a certificate authority, mobile device 108 is further configured to validate the certificate. In another example embodiment where the service data comprises a certificate signed by a registration authority, mobile device 108 is further configured to validate the certificate.

FIG. 2 illustrates an example of a wireless local area network 200 with a service provider network 202 comprising a Service provider (in this example a MSAP Service Provider) 204, e.g. a server. MSAP Service provider 204 can be employed to configure and/or update MSAP server 106. In an example embodiment, the provider of the service obtains a valid x.509 certificate from a (for example Concierge) Certificate Authority/Registration Authority (CA/RA) that is used to prove MSAP Service Provider's 204 authorization to provide a service as defined in the service data. MSAP Server 106 obtains a valid x.509 certificate from the (e.g. Concierge) CA/RA to prove that MSAP server 106 is authorized to provide MSAP services and carry forward Service Provider's 204 service data used in the advertisement exchange. A trust relationship can be established between MSAP server 106 and MSAP Service Provider 204 to allow for out-of-band dynamic updates of service data. Optionally, updates may not be dynamic and are obtained through other means. In an example embodiment, a trust relationship is established between MSAP server 106 and the Access Network Provider (ANP—illustrated as AP 104 in this example for simplicity). A secure communication channel can be established between MSAP server 106 and AP 104 as AP 104 will be forwarding Service Advertisement Requests to MSAP server 106 and the response from MSAP server 106 to mobile device (or endpoint) 108. In an example embodiment, during network configuration, the bindings of MSAP services to AP 104's capabilities (e.g. BSSID, SSID, MSAP-realms) are defined at MSAP server 106. In an example embodiment, mobile device 108 is configured with polices (e.g. certificates) to enable MSAP and to select MSAP services validated by a pre-provisioned certificate.

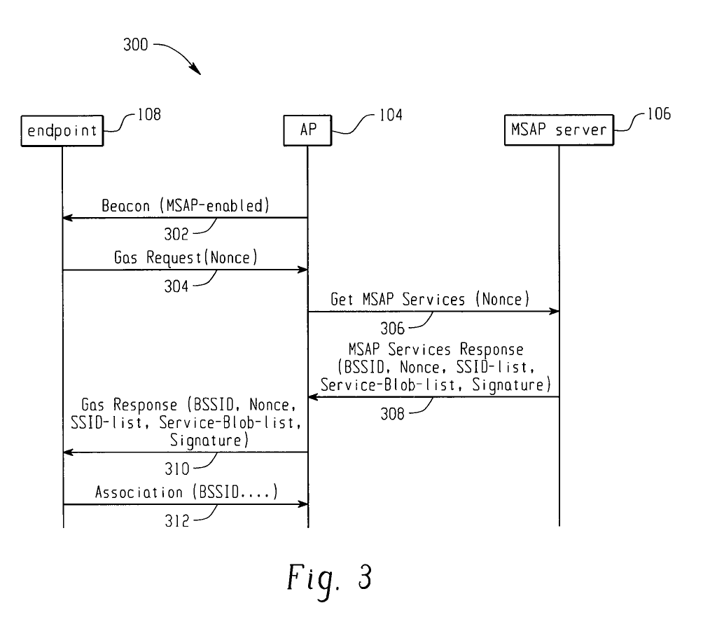

FIG. 3 illustrates an example signal diagram 300 for a wireless mobile unit to receive advertising services from a wireless local area network. Signal diagram 300 is directed to network 100 described in FIG. 1 but is also can be implemented in network 200 illustrated in FIG. 2. Mobile device (endpoint) 108 receives beacon 302 from AP 104. Beacon 302 comprises data indicating it supports advertising services (in this example MSAP but any suitable protocol can be advertised in this manner). Mobile device 108 sends request 304 to obtain available services from AP 104. In this example, request 304 is a Generic Advertising Service (GAS) request. For additional security, a nonce may be included with request 304. This can protect against replay attacks.

Signal 306 sent by AP 104 forwards request 304 to MSAP server 106. In this example, signal 306 is a Get MSAP Services request, with a nonce sent by mobile device 108.

MSAP server 106 generates a response to the request to obtain available services from mobile device 108 and forwarded by AP 104. In this example, the response comprises a Basic Service Set Identifier (BSSID), the nonce sent by mobile device 108 in the original request, a SSID list corresponding to available services, additional network data and service data (for example a Binary Large Object “BLOB”-list), and a signature. The signature binds the network data and service data. For example, the signature may bind the BSSID, SSID list, nonce, and additional network data and service data. For example the signature may be generate by RSA (MSAP-Server_Private-Key, (SHA-256 (Nonce|Service data|network data)). The response (in this example MSAP Services Response that includes the BSSID, nonce, SSID-list, Service-BLOB-list, and signature) is forwarded to AP 104 as illustrated by signal 308. AP then forwards the response from MSAP server 106 response (in this as a GAS response) to mobile device 108 as illustrated by signal 310.

Mobile device 308 validates signal 310. If signal 310 is authentic, then mobile device may continue communicating with AP 104. For example, mobile device 108 may Associate with AP 104 as illustrated by signal 312 with the SSID indicated in the MSAP Services Response. As another example, mobile device may provide an output on a user interface (not shown) and if an input is received indicating a service has been selected, then mobile device 108 may associate with AP 104 using a SSID corresponding to the selected service. If, however, signal 308 cannot be validated, then mobile device 108 may discontinue communicating with AP 104.

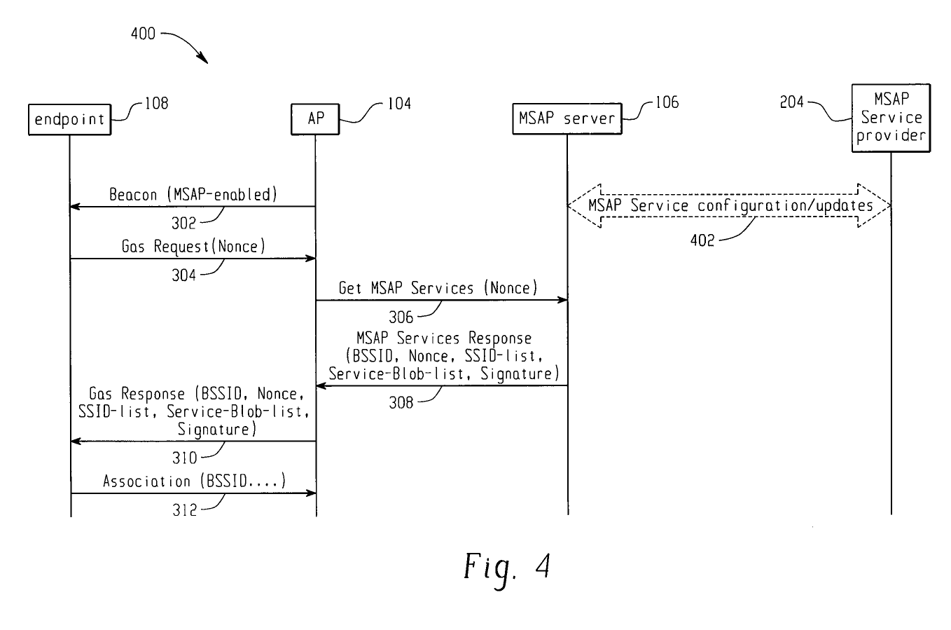

FIG. 4 illustrates an example signal diagram 400 for a wireless mobile unit to receive advertising services from a wireless local area network that includes an external service provider. In this example there is a relationship between the MSAP server and the Service Provider (SP). Signal diagram 400 is illustrated using network 200 in FIG. 2 that employs a MSAP Service Provider 204. MSAP Service Provider 204 provider may send MSAP Service configuration and/or updates to MSAP server 106 as illustrated by signal 402. Signal 402 may suitably comprise a plurality of signals. MSAP service configuration/updates may be sent out of band at any time, and thus signal 402 should not be construed as only occurring in the order as illustrated in FIG. 4.

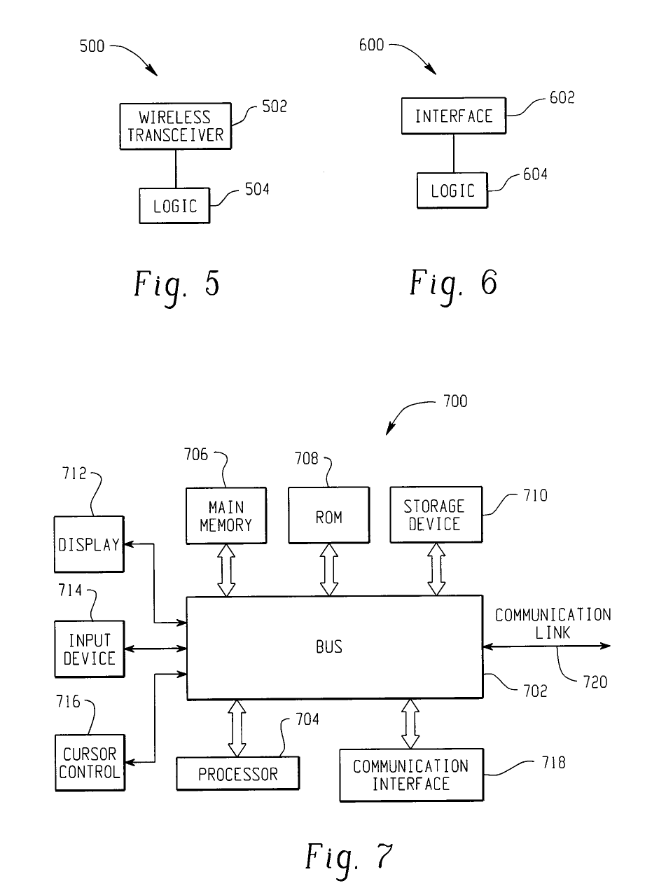

FIG. 5 is a block diagram of a mobile device 500 upon which an example embodiment may be implemented. Mobile device 500 is suitable to implement the functionality of mobile device 108 (FIGS. 1-4). Mobile device 502 comprises a wireless transceiver 502 which is configured to send and receive wireless signals. Logic 504 coupled to wireless transceiver is configure to send and receive data via wireless transceiver 502. Logic 504 can be configured to implement the functionality described herein with reference to mobile device 108 (FIGS. 1-4). For example, mobile device 500 can receive signals (for example passively receive beacons or actively by sending probe signals and waiting for responses to the probe signals) via wireless transceiver 502. Logic 504 can determine from the beacons whether the source of the beacon supports a network advertising protocol such as MSAP or a protocol compatible with the proposed 802.11u protocol. Logic 504 may also use data representative of available services to aid in selecting a connection to a network as well (for example which AP and with which SSID). Logic 504 can then send a signal via wireless transceiver 502 to request available services. Logic 504 may also generate a nonce to include in the signal sent via wireless transceiver 502. A response to the request can be received via wireless transceiver 502. Logic 504 can authenticate the response by employing any suitable technique, such as those described herein. For example, logic 504 can determine whether the response contains a signature that has cryptographically bound network data (such as the BSSID of the source of the beacon) and service data (such as an icon, or a reference to an icon for advertising the service). Logic 504 may be configured with certificates verifying signatures. In particular embodiments, logic 504 is configured with a public key for an advertising server (such as a MSAP server). In particular embodiments, logic 504 may select a connection to a network (or a network) based on data acquired in the Service Advertisement process. For example, logic 504 may determine whether to stay with an AP using a designated SSID or move to a different AP (and even a different network).

FIG. 6 is a block diagram of a server 600 upon which an example embodiment may be implemented. Server 600 is suitable to implement an advertising server such as MSAP server 106 (FIGS. 1-4). Server 600 comprises an interface (transceiver) 602 for sending and receiving signals and logic 604 for implementing the functionality described herein. In an example embodiment, server 600 comprises a single interface that communicates with an access network provider (ANP, such as AP 104 in FIGS. 1-4) and a service provider (such as Service provider 204 in FIGS. 2 and 4). In an alternative embodiment, interface 602 comprises multiple interfaces. For example a first interface may be employed for communicating with an ANP and a second interface for communicating with a service provider.

In an example embodiment, logic 604 is configured to receive configuration and/or update data from a service provider via interface 602. The configuration and/or update data can be received out of band at any time.

In an example embodiment, logic 604 is further configured to respond to requests for advertising services. For example a Get MSAP services request as described in FIG. 3. Logic 604 may be configured to generate a list of available services. The list may be bound with a BSSID of the ANP and other network data (such as SSID's corresponding to the available services). For example, the information may be hashed (SHA-256) and a signature can be generated by RSA encryption using a private key. Logic 604 then sends the response via interface 602.

FIG. 7 illustrates an example of a computer system 700 upon which an example embodiment may be implemented. Computer system 700 is suitable for implementing logic 504 (FIG. 5) and/or logic 604 (FIG. 6), which may be employed for implementing the functionality of mobile device 108 (FIGS. 1-4) and server 106 (FIG. 104).

Computer system 700 includes a bus 702 or other communication mechanism for communicating information and a processor 704 coupled with bus 702 for processing information. Computer system 700 also includes a main memory 706, such as random access memory (RAM) or other dynamic storage device coupled to bus 702 for storing information and instructions to be executed by processor 704. Main memory 706 also may be used for storing temporary variable or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

In an example embodiment, for example when computer system 700 is being employed to implement mobile device 108, computer system 700 may be coupled via bus 702 to a display 712 such as a cathode ray tube (CRT) or liquid crystal display (LCD), for displaying information to a computer user. An input device 714, such as a keyboard including alphanumeric and other keys is coupled to bus 702 for communicating information and command selections to processor 704. Another type of user input device is cursor control 716, such as a mouse, a trackball, touch screen, or cursor direction keys for communicating direction information and command selections to processor 704 and for controlling cursor movement on display 712. This input device typically has two degrees of freedom in two axes, a first axis (e.g. x) and a second axis (e.g. y) that allows the device to specify positions in a plane.

An aspect of the example embodiment is related to the use of computer system 700 for authenticating mobile device advertisements. According to an example embodiment, authenticating mobile device advertisements is provided by computer system 700 in response to processor 704 executing one or more sequences of one or more instructions contained in main memory 706. Such instructions may be read into main memory 706 from another computer-readable medium, such as storage device 710. Execution of the sequence of instructions contained in main memory 706 causes processor 704 to perform the process steps described herein. One or more processors in a multi-processing arrangement may also be employed to execute the sequences of instructions contained in main memory 706. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 704 for execution. Such a medium may take many forms, including but not limited to non-volatile media, and volatile media. Non-volatile media include for example optical or magnetic disks, such as storage device 710. Volatile media include dynamic memory such as main memory 706. Common forms of computer-readable media include for example floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Various forms of computer-readable media may be involved in carrying one or more sequences of one or more instructions to processor 704 for execution. For example, the instructions may initially be borne on a magnetic disk of a remote computer. The remote computer can load the instructions into its dynamic memory and send the instructions over a telephone line using a modem. A modem local to computer system 700 can receive the data on the telephone line and use an infrared transmitter to convert the data to an infrared signal. An infrared detector coupled to bus 702 can receive the data carried in the infrared signal and place the data on bus 702. Bus 702 carries the data to main memory 706 from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling computer system 700 to a network link 720 that is connected to a local network 720. This allows computer system 700 to communicate with other devices.

For example, communication interface 718 may be a local area network (LAN) card to provide a data communication connection to a compatible LAN. As another example, communication interface 718 may be an integrated services digital network (ISDN) card or a modem to provide a data communication connection to a corresponding type of telephone line. Wireless links may also be implemented. In any such implementation, communication interface 718 sends and receives electrical, electromagnetic, or optical signals that carry digital data streams representing various types of information.

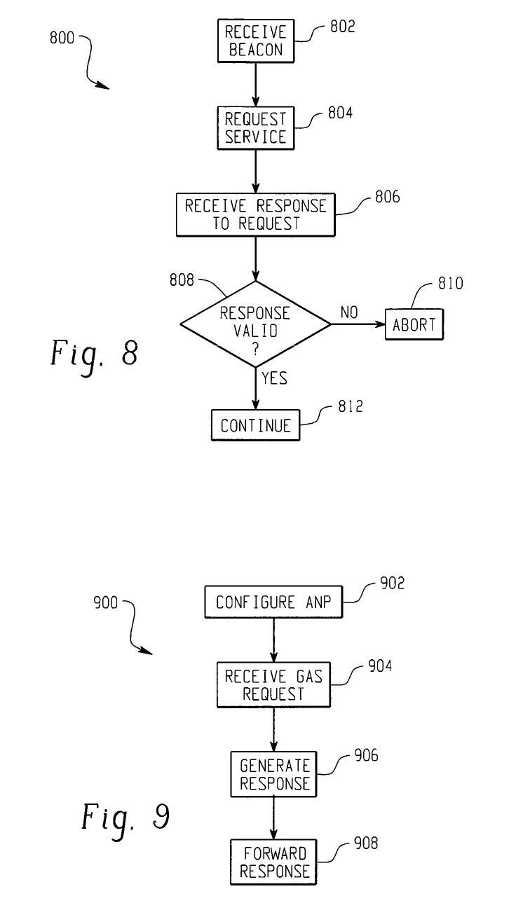

In view of the foregoing structural and functional features described above, a methodologies in accordance with example embodiments will be better appreciated with reference to FIGS. 8 and 9. While for purposes of simplicity of explanation, the methodologies of FIGS. 8 and 9 are shown and described as executing serially, it is to be understood and appreciated that the example embodiments are not limited by the illustrated orders, as some aspects could occur in different orders and/or concurrently with other aspects from that shown and described herein. Moreover, not all illustrated features may be required to implement the methodologies described herein. The methodologies described herein are suitably adapted to be implemented in hardware, software, or a combination thereof.

FIG. 8 illustrates an example of a methodology 800 performed by a mobile device to obtain network advertising services. Methodology 800 may be implemented by mobile device 108 described in FIGS. 1-4 herein.

At 802, a signal is received that comprises data indicating that the source of the signal (for example an ANP or AP) has mobile service (such as Concierge) advertising capabilities for advertising available network services. The signal may be a beacon, or a response sent to a probe signal.

At 804, a request for available services is sent to the source of the beacon (for example an ANP or AP). The request may be a Generic Advertising Service request. In particular embodiments, the request includes a nonce.

At 806, a response to the request is received. In an example embodiment, the response includes the BSSID of the ANP, nonce, network data, service data and a signature. The network data and service data may include many different types of data as described herein. For example network data may include a domain name for the service provider and the service data may include a URL, icon, and/or a reference to an icon.

At 808, the device receiving the response validates the signature. In an example embodiment, the signature is validated using a public key for the source of the response (for example a server such as a MSAP server). In an example embodiment, the device receiving the response determines whether the signature comprises network data cryptographically bound to service data. In particular embodiments, the receiving device verifies the signature comprises a nonce that was sent in the request for available service.

If at 808, the response is determined to be invalid, at 810 communications is terminated (aborted). In a Concierge environment, this prevents rogue devices from presenting icons and advertising services on a mobile device. This can also prevent phishing attacks and/or spam.

If at 810, the response is determined to be valid, at 812 communications for determining network selection may continue. For example, in a concierge environment, an icon or other output (such as video, audio, audiovisual, etc.) may be output via a user interface. If an input is received indicating a selection of a particular service, a mobile device may associate with the ANP by using the BSSID and SSID for the selected service.

FIG. 9 illustrates an example of a methodology 900 performed by a server to provide advertising services available from an associated network. Methodology 900 may be implemented by MSAP server 106 described in FIGS. 1-4 herein.

At 902, the server configures an ANP to advertise available services. For example, an AP may be provided with data to include in beacons sent by the AP for advertising that the network supports an advertising protocol (such as MSAP). In particular embodiments, the ANP may is updated.

AT 904, the server receives a request for available services. For example, the request may be a Generic Advertising Service request. In particular embodiments, the request further comprises a nonce.

At 906, a response to the request is generated. The response generally includes a list of available services. The list may include service set identifiers where a service set identifier is associated with each available service. In addition the response may include the BSSID of the ANP that originally received the request. The request may also include other service data such as an icon (or a reference for getting an icon), service provider identity, service URL, a public key, MSAP server identity, a certificate signed by a CA/RA. Network data may include the BSSID, SSID list of SSID's that can provide the advertised service, network identity such as a domain name, NAI, and/or HESSID, and/or 802.11 association capabilities such as Extensible Authentication Protocol (EAP) method, credential type, etc. In an example embodiment, the server constructs an authenticated response that includes the nonce, service data, network data and a MIC that can be defined as RSA (Server-Private-Key, SHA-#bits (Nonce|service data|network data)).

At 908, the response is forwarded. For example, the response may be forwarded to an AP for forwarding to a mobile device that sent the request.

Described above are example embodiments. It is, of course, not possible to describe every conceivable combination of components or methodologies, but one of ordinary skill in the art will recognize that many further combinations and permutations of the example embodiments are possible. Although the above description describes a wireless network, those skilled in the art should readily appreciate that wireless network was described merely for ease of illustration and that the principles described herein are also suitably adaptable to wired networks. Accordingly, this application is intended to embrace all such alterations, modifications and variations that fall within the spirit and scope of the appended claims interpreted in accordance with the breadth to which they are fairly, legally and equitably entitled.

1. An apparatus, comprising:
a transceiver configured to send and receive data;
logic coupled to the transceiver;
wherein the logic is configured to determine from a signal received by the transceiver whether an associated device sending the signal supports a protocol for advertising available services from the associated device;
wherein the logic is configured to send a request for available services from the associated device via the transceiver responsive to determining the associated device supports the protocol;
wherein the logic is configured to receive a response to the request via the transceiver, the response comprising a signature; and
wherein the logic is configured to validate the response by confirming the signature comprises network data cryptographically bound with service data.

2. The apparatus set forth in claim 1, wherein the request for available services comprises a nonce; and
wherein the logic is further configured to validate the request by verifying the signature includes the same nonce.

3. The apparatus set forth in claim 1, wherein the network data comprises a service set identifier.

4. The apparatus set forth in claim 1, wherein the network data comprises a service set identifier corresponding to an advertised service.

5. The apparatus set forth in claim 1, wherein the network data comprises a plurality of service set identifiers corresponding to a plurality of advertised services.

6. The apparatus set forth in claim 1, wherein the network data comprises a domain name.

7. The apparatus set forth in claim 1, wherein the network data comprises a network access identifier.

8. The apparatus set forth in claim 1, wherein the network data comprises a homogeneous extended service set identifier.

9. The apparatus set forth in claim 1, wherein the service data comprises an icon image.

10. The apparatus set forth in claim 1, wherein the service data comprises data referencing an icon.

11. The apparatus set forth in claim 1, wherein the service data comprises a service provider identity.

12. The apparatus set forth in claim 1, wherein the service data comprises a service Uniform Resource Locator.

13. The apparatus set forth in claim 1, wherein the service data comprises a public key.

14. The apparatus set forth in claim 1, wherein the service data comprises a certificate signed by a certificate authority; and
wherein the logic is further configured to validate the certificate.

15. The apparatus set forth in claim 1, wherein the service data comprises a certificate signed by a registration authority; and
wherein the logic is further configured to validate the certificate.

16. An apparatus, comprising:
a transceiver configured to send and receive data;
logic coupled to the transceiver;
wherein the logic is configured to receive a get advertising services request from the transceiver;
wherein the logic is configured to generate a response to the get advertising request, the response comprising a signature that comprises network data cryptographically bound with service data; and
wherein the logic is configured is configured to send the response to the get advertising request via the wireless transceiver.

17. The apparatus set forth in claim 16, wherein the get advertising request comprises a nonce;
wherein the nonce is cryptographically bound to network data and service data;
wherein the network data comprises a basic service set identifier for the access network provider, at least one service set identifier corresponding to an at least one service; and
wherein the service data comprises a uniform resource locator and one of a group consisting of an icon and data referencing an icon.

18. A method, comprising:
receiving a signal from an access network provider;
determining from the signal whether the access network provider supports a protocol for advertising available services;
requesting a list of available services from the access network provider;
receiving a response to the request, the response comprising a signature; and
validating the response, wherein validating the response comprises confirming the signature comprises network data cryptographically bound with service data.

19. The method set forth in claim 18, wherein the request for available services comprises a nonce; and
validating the signature further comprises verifying the signature includes the nonce.

20. The method set forth in claim 18, wherein the network data comprises a basic service set identifier and the service data comprises a service uniform resource locator.
